(19) United States
(12) Patent Application Publication
(10) Pub. No.: US 2022/0300424 A1
(43) Pub. Date: Sep. 22, 2022

(54) MEMORY SYSTEM, CONTROL METHOD, AND MEMORY CONTROLLER

(71) Applicant: Kioxia Corporation, Tokyo (JP)

(72) Inventor: Mitsunori TADOKORO, Fujiusawa Kanagawa (JP)

(21) Appl. No.: 17/472,402

(22) Filed: Sep. 10, 2021

(30) Foreign Application Priority Data
Mar. 18, 2021 (JP) 2021-044451

(51) Int. Cl. G06F 12/0864; G06F 3/06

(52) U.S. Cl. CPC G06F 12/0864; G06F 3/0656; G06F 3/0604; G06F 3/0679; G06F 2212/6032

(57) ABSTRACT

A memory system according to an embodiment includes a first memory, a second memory, and a controller. The first memory stores first information that associates each of logical addresses indicating positions in a logical address space with a corresponding one of physical addresses indicating physical positions in the first memory. The second memory includes a cache area storing second information that is a part of the first information. The controller includes a first circuit controlling access to the first memory and a second circuit controlling access to the second memory. When cache miss occurs, the controller executes first processing of transmitting a first request for preparation of a cache entry of the second information to the first circuit and second processing of providing a second request regarding the cache entry to the second circuit in response to reception of notification indicating completion of the preparation of the cache entry.

### CROSS-REFERENCE TO RELATED APPLICATIONS

This application is based upon and claims the benefit of priority from Japanese Patent Application No. 2021-044451, filed on Mar. 18, 2021; the entire contents of which are incorporated herein by reference.

### FIELD

Embodiments described herein relate generally to a memory system, a control method, and a memory controller.

### BACKGROUND

Conventionally, a memory system including a non-volatile memory is known. An example of the non-volatile memory is a NAND flash memory.

The memory system stores address translation information regarding a plurality of addresses in the non-volatile memory as a lookup table (LUT). The address translation information is information that associates logical addresses indicating positions in a logical address space with physical addresses indicating positions in the non-volatile memory.

As described above, in a case where a certain logical address is translated into a physical address, the memory system requires address translation information that associates the logical address with the physical address. However, because the access speed to the non-volatile memory is not so high, time required for the address translation processing increases in a case where the address translation information is acquired from the non-volatile memory. Under such circumstances, to enable the address translation information to be acquired at higher speed, the memory system is provided with a cache memory that can be accessed at higher speed than the non-volatile memory. During operation of the memory system, a part of a group of the address translation information is stored in the cache memory as cache data.

In the memory system, it is required to suitably control the part of the address translation information stored in the cache memory.

### BRIEF DESCRIPTION OF THE DRAWINGS

FIG. 1 is a schematic view illustrating an example of a configuration of a memory system according to a first embodiment;

FIG. 2 is a schematic view illustrating an example of a way in a cache memory included in a RAM according to the first embodiment;

FIG. 3 is a flowchart schematically illustrating a flow of refill processing by an LUT cache management module according to the first embodiment;

FIG. 4 is a diagram schematically illustrating an operation of the refill processing by the LUT cache management module according to the first embodiment;

FIG. 5 is a diagram schematically illustrating a functional configuration of a refill processing by a LUT cache management module according to a second embodiment;

FIG. 6A is a diagram schematically illustrating a part of the operation of the refill processing by the LUT cache management module according to the second embodiment;

FIG. 6B is a diagram schematically illustrating another part of the operation of the refill processing by the LUT cache management module according to the second embodiment;

FIG. 6C is a diagram schematically illustrating still another part of the operation of the refill processing by the LUT cache management module according to the second embodiment;

FIG. 6D is a diagram schematically illustrating still another part of the operation of the refill processing by the LUT cache management module according to the second embodiment;

FIG. 6E is a diagram schematically illustrating still another part of the operation of the refill processing by the LUT cache management module according to the second embodiment;

FIG. 6F is a diagram schematically illustrating still another part of the operation of the refill processing by the LUT cache management module according to the second embodiment; and

FIG. 6G is a diagram schematically illustrating still another part of the operation of the refill processing by the LUT cache management module according to the second embodiment.

### DETAILED DESCRIPTION

A memory system according to an embodiment includes a non-volatile first memory configured to store data in a non-volatile manner, a second memory, and a controller. The first memory is configured to store first information that associates each of a plurality of logical addresses indicating a plurality of positions in a logical address space of the memory system with a corresponding one of physical addresses indicating physical positions in the first memory. The second memory includes a set-associative cache area storing second information that is a part of the first information regarding the plurality of logical addresses. The controller includes a first circuit configured to control access to the first memory for the first information and a second circuit configured to control access to the second memory. The controller is configured to execute third processing including first processing and second processing when a result of a search of a first logical address in the cache area storing the second information is a cache miss, the first processing being a process of transmitting a first request for preparation of a cache entry of the second information to the first circuit, the second processing being a process of providing a second request regarding the cache entry to the second circuit in response to reception of notification indicating completion of the preparation of the cache entry from the first circuit.

Exemplary embodiments of a memory system, a control method, and a memory controller will be explained below in detail with reference to the accompanying drawings.

### First Embodiment

[Configuration of Memory System]

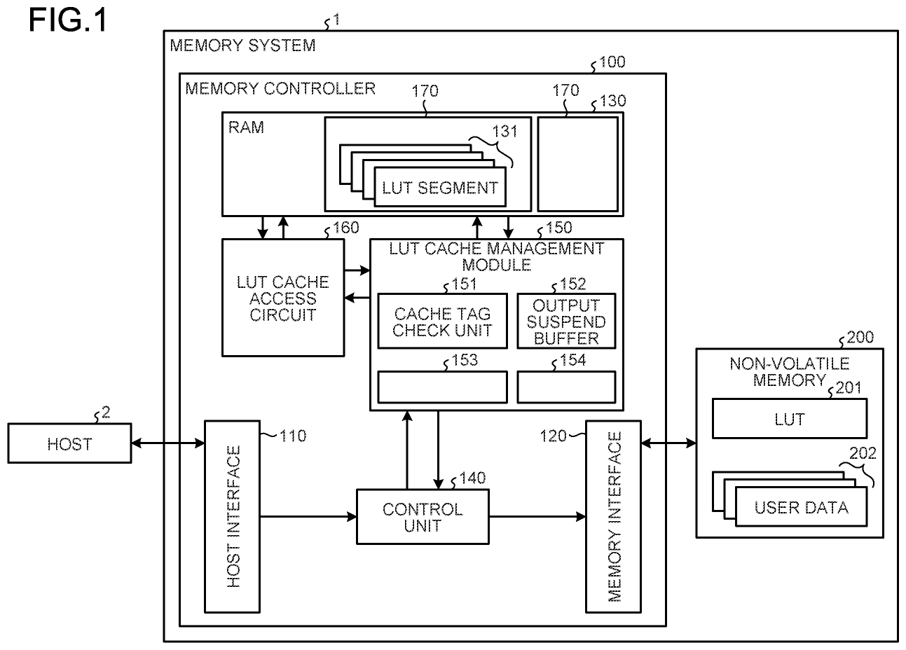

FIG. 1 is a schematic view illustrating an example of a configuration of a memory system according to a first embodiment. As illustrated in FIG. 1, a memory system 1 is connectable to a host 2. FIG. 1 depicts a state of the memory system 1 connected to the host 2. A standard for connection between the memory system 1 and the host 2 is not limited to a specific standard. The host 2 is, for example, a personal computer, a portable information terminal, an in-vehicle terminal, or a server.

When accessing the memory system 1, the host 2 transmits an access command (for example, a read command or a write command) to the memory system 1. Each access command is accompanied by a logical address. The logical address is information indicating a position in a logical address space provided by the memory system 1 to the host 2. The host 2 transmits data to be written together with the write command. The data to be written transmitted together with the write command and data to be written stored in the memory system 1 are both referred to as user data.

The memory system 1 includes a memory controller 100 and a non-volatile memory 200. The non-volatile memory 200 is a non-volatile memory that stores data into a non-volatile manner, and is, for example, a NAND flash memory (hereinafter referred to simply as a NAND memory). In the following description, a case where the NAND memory is used as the non-volatile memory 200 will be exemplified. But a storage device other than the NAND memory, such as another type of flash memory having three-dimensional structure, a resistive random access memory (ReRAM), a ferroelectric random access memory (FeRAM), a phase change memory (PCM), and a magnetoresistive random access memory (MRAM), can be used as the non-volatile memory 200. Also, the non-volatile memory 200 is not necessarily a semiconductor memory, and the present embodiment can also be applied to various storage media other than the semiconductor memory.

The memory system 1 may be any of various memory systems including the non-volatile memory 200, such as a solid state drive (SSD), a universal flash storage (UFS) device, and a memory card.

The non-volatile memory 200 is an example of a first memory. In the non-volatile memory 200, a lookup table (LUT) 201 described below is stored.

In a case where the non-volatile memory 200 is a NAND memory, the non-volatile memory 200 includes a memory cell array having a plurality of blocks. Data stored in each block is erased collectively. Each block includes a plurality of pages. Writing of data into the memory cell array and reading of data from the memory cell array are executed per page unit. In the non-volatile memory 200, the LUT 201 and user data 202 are stored.

The LUT 201 is address translation information that associates each of a plurality of logical addresses with a corresponding one of physical addresses indicating positions in the non-volatile memory 200. The LUT 201 has a data structure in which the physical addresses corresponding to the logical addresses, each of which serves as an entry, are arranged in the order of the logical addresses. Note that the data structure of the address translation information is not limited thereto.

The memory controller 100 includes a host interface 110, a memory interface 120, a random access memory (RAM) 130, a control unit 140, an LUT cache management module 150, and an LUT cache access circuit 160.

Some of the respective components included in the memory controller 100 may include a circuit achieved by operation based on a computer program. Also, some or all of the respective components included in the memory controller 100 may include a hardware circuit such as a field-programmable gate array (FPGA) and an application specific integrated circuit (ASIC). An example of such a circuit is a processor such as a central processing unit (CPU) and a micro processor unit (MPU). That is, the memory controller 100 can be implemented by hardware, software, or a combination thereof. Note that the memory controller 100 can be configured by a semiconductor device such as a system-on-a-chip (SoC). The memory controller 100 may be configured by a plurality of chips.

A program executed by the memory controller 100 according to the present embodiment is stored in advance in the non-volatile memory 200, a not-illustrated ROM, or the like and is provided.

The program executed by the memory controller 100 according to the present embodiment may be configured to be provided as a computer program product by being recorded as a file in an installable format or an executable format in a computer-readable recording medium such as a compact disc read only memory (CD-ROM), a flexible disk (FD), a compact disc recordable (CD-R), and a digital versatile disc (DVD).

Further, the program executed by the memory controller 100 according to the present embodiment may be configured to be stored on a computer connected to a network such as the Internet, downloaded via the network, and provided.

The host interface 110 is an interface device or a circuit that executes transmission and reception of a command and the user data 202 between the host 2 and the memory controller 100. The memory interface 120 is an interface device or a circuit that executes access to the non-volatile memory 200.

The RAM 130 includes a memory of a type that can be accessed at higher speed than the non-volatile memory 200. The RAM 130 may be a volatile memory or a non-volatile memory. The RAM 130 includes, for example, a dynamic random access memory (DRAM) or a static random access memory (SRAM). Note that the memory serving as the RAM 130 is not limited to the above-described type of memory. The RAM 130 may be provided outside the memory controller 100.

The RAM 130 includes a storage area used as a set-associative cache memory having a plurality of ways 170. The cache memory of the RAM 130 includes the plurality of ways 170. Each of the ways 170 stores a plurality of LUT segments 131. The plurality of LUT segments 131 are provided with index numbers that respectively identify the LUT segments 131. The RAM 130 is an example of a second memory.

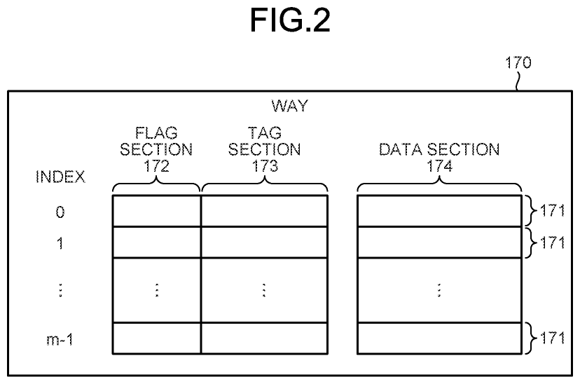

Here, the way 170 will be described with reference to FIG. 2. FIG. 2 is a schematic view illustrating an example of the way in the cache memory included in the RAM 130. In the example illustrated in FIG. 2, the way 170 includes m cache lines 171. Here, m is a positive integer.

The m cache lines 171 are respectively provided with serial numbers called indices. The head cache line 171 is provided with an index number 0. In a case where m is 2 or more, each of the cache lines 171 other than the head cache line 171 is provided as the index with any value in a range from 1 to (m−1) indicating a relative position to the head cache line 171.

Each of the cache lines 171 includes a flag section 172, a tag section 173, and a data section 174. Note that the flag section 172 and the tag section 173 are only required to be associated with the data section 174 on a one-to-one basis. For example, the flag section 172 and the tag section 173, and the data section 174 may be stored in different positions in the RAM 130, respectively. The flag section 172 and the tag section 173 may be stored outside the RAM 130. The flag section 172 and the tag section 173 may be referred to as management information.

In the data section 174, the LUT segment 131 serving as data to be stored in the cache memory is stored. The LUT segment 131 is data (first information) generated by copying a part of the LUT 201. The LUT segment 131 includes address translation information regarding each of a particular number of consecutive logical addresses. That is, the LUT segment 131 has a data structure in which physical addresses respectively corresponding to the particular number of consecutive logical addresses are arranged in the order of the logical addresses.

In the tag section 173, information called a tag is stored. In the flag section 172, one or more pieces of flag information used for controlling the cache line 171 is/are stored.

The flag information includes, for example, information indicating a cache hit or a cache miss to be described below. Note that examples of the flag information are not limited thereto.

Each of the plurality of ways 170 in the cache memory included in the RAM 130 has a similar configuration to the way 170 illustrated in FIG. 2.

The description returns to FIG. 1.

The control unit 140 is a device or a circuit that integrally controls the operation of the memory controller 100 in accordance with firmware (FW) which is an example of a computer program. In particular, the control unit 140 receives a command from the host 2 via the host interface 110 and analyzes the received command. Then, the control unit 140 instructs the memory interface 120 to perform operation to the non-volatile memory 200 in accordance with the analysis result. For example, in a case of receiving an access command from the host 2, the control unit 140 instructs the memory interface 120 to execute access to the non-volatile memory 200 corresponding to the received access command.

In a case where the access command received from the host 2 is a write command, the control unit 140 controls writing of the user data 202 into the non-volatile memory 200 and updates the address translation information regarding the user data 202.

In a case where the access command received from the host 2 is a read command, the control unit 140 looks up address translation information regarding a logical address designated by the read command to translate the logical address into a physical address. Also, the control unit 140 controls reading of the user data 202 from the non-volatile memory 200.

The control unit 140 can use the LUT segment 131 including the address translation information to be updated or looked up by transmitting the logical address to the LUT cache management module 150.

The LUT cache management module 150 is a module that manages a storage position of a part of the LUT 201 into the LUT segment 131 on the RAM 130. Note that the LUT cache management module 150 does not access the data section 174 of the way 170. The LUT cache management module 150 includes, for example, a hardware circuit. Note that the LUT cache management module 150 may be achieved as a processor executes a computer program.

Meanwhile, there is a case where the LUT 201 cannot be stored in the cache memory, and in which refill processing of replacing a cache entry is required. In this case, the LUT cache management module 150, which manages storage of the LUT 201 into the cache memory, notifies the firmware (FW) of the control unit 140 of LUT access (a lookup request or an update request) that is not ready for execution. The firmware that has received the LUT access performs the refill processing of replacing the cache entry. That is, in a case where the LUT 201 is not stored in the cache memory, the LUT cache management module 150 causes LUT access processing to the LUT 201 to be suspended until the refill processing of replacing the cache entry is completed.

A conventional control unit performs processing of putting the LUT access (request) into a suspend queue and then re-providing the request in the suspend queue, in addition to the refill processing of replacing the cache entry.

Here, the LUT cache management module 150 includes a cache tag check unit 151, an output suspend buffer 152, a lookup request queue 153, and an update request queue 154 as functional units that fulfill a function of managing the refill processing.

The lookup request queue 153 is a queue into which a lookup request, which is a lookup request for requesting lookup of target address translation information, is put. The update request queue 154 is a queue into which an update request, which is an update request for requesting update of target address translation information, is put.

The cache tag check unit 151 first performs a search in the RAM 130 in response to receiving from the control unit 140 a logical address corresponding to a request (a lookup request or an update request) put in the lookup request queue 153 or the update request queue 154. The cache tag check unit 151 determines whether the result of the search is a cache hit or a cache miss. In a case where the result of the search is a cache miss, the cache tag check unit 151 transmits a refill request to the control unit 140.

The output suspend buffer 152 is a ring buffer in which the head of the buffer area is next to the tail thereof.

The LUT cache access circuit 160 is a circuit that executes access (lookup, update, or the like) to the LUT segment 131 on the RAM 130 (particularly, the cache memory). The LUT cache access circuit 160 is also referred to as an access engine. The LUT cache access circuit 160 adds a result (lookup data) of accessing the LUT segment 131 to the input and outputs the result. Specifically, a read (lookup) or write (update) request is transmitted from the control unit 140 via the LUT cache management module 150 to the LUT cache access circuit 160. The LUT cache access circuit 160 outputs a result of accessing the LUT segment 131 on the RAM 130 to the control unit 140 via the LUT cache management module 150. At the time of the read request, the control unit 140 issues the read request to the non-volatile memory 200 on the basis of the result. That is, the LUT cache access circuit 160 looks up and updates the LUT segment 131 on the RAM 130 on the basis of the storage position of the LUT segment 131 on the RAM 130 indicated by the LUT cache management module 150.

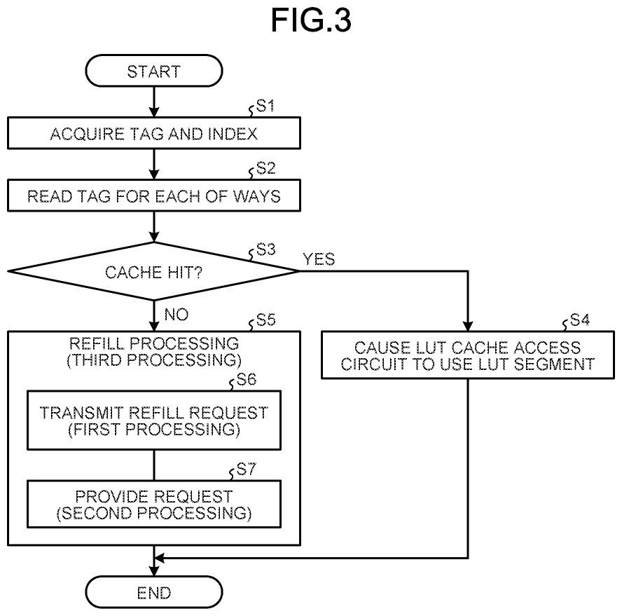

The cache tag check unit 151 of the LUT cache management module 150 will be described in detail below. Here, FIG. 3 is a flowchart schematically illustrating a flow of the refill processing by the cache tag check unit 151 of the LUT cache management module 150.

Specifically, the cache tag check unit 151 first acquires a tag and an index from a bit string of a logical address received from the control unit 140 (S1). The cache tag check unit 151 reads a tag from the tag section 173 of the cache line 171 indicated by the acquired index for each of the ways 170 in the cache memory (S2). The cache tag check unit 151 then compares the tag read from each of the ways 170 with the tag acquired from the logical address, and determines whether the comparison result is a cache hit or a cache miss (S3).

In a case where any of the tags read from the respective ways 170 matches to the tag acquired from the logical address, that is, in a case in which the result of the search is a cache hit (Yes in S3), the cache tag check unit 151 causes the LUT cache access circuit 160 to use the LUT segment 131 stored in the data section 174 of the cache line 171 from which the tag matching to the tag acquired from the logical address is read (S4).

In a case where there is no tag that matches to the tag acquired from the logical address among the tags read from the respective ways 170, that is, in a case where the result of the search is a cache miss (No in S3), the cache tag check unit 151 performs the refill processing (third processing) (S5).

The refill processing (S5) is processing of reading the LUT segment 131 including the address translation information that associates the target logical address with the physical address from the LUT 201 stored in the non-volatile memory 200, and storing the read LUT segment 131 in any of the ways 170.

Meanwhile, an LUT cache management module according to a comparative example performs determination of whether the result is a cache hit or a cache miss and state transition of an LUT segment (referred to also as a cache entry) generated by copying a part of an LUT. Therefore, a processing load of a control unit (firmware) increases.

Specifically, the control unit executes processing of selecting a suspend queue for putting a request that has been suspended due to a cache miss or the like, processing of putting the suspended request into the suspend queue, processing of taking out the request from the suspend queue after completion of refill with the cache entry and re-providing the request to the LUT cache management module, and the like. Each of these pieces of processing is simple, but imposes a large processing load of the control unit. Such a large processing load of the control unit becomes a bottleneck in lookup or update processing for the address translation information in a case where a cache miss occurs.

Therefore, in the present embodiment, at the time of the refill processing (at the time of the cache miss), the LUT cache management module 150 executes processing (first processing) of preparing the LUT segment 131 (referred to also as a cache entry) generated by copying a part of the LUT 201, that is, transmitting a refill request (S6), and processing (second processing) of providing a request to the LUT cache access circuit 160 after waiting for completion of the preparation of the cache entry (S7). The LUT cache management module 150 executes these two pieces of processing in pipeline processing using two processing stages to execute LUT cache, in which a part of the LUT 201 is cached into the cache memory. The details will be described below.

[Functional Configuration in Refill Processing of LUT Cache Management Module 150]

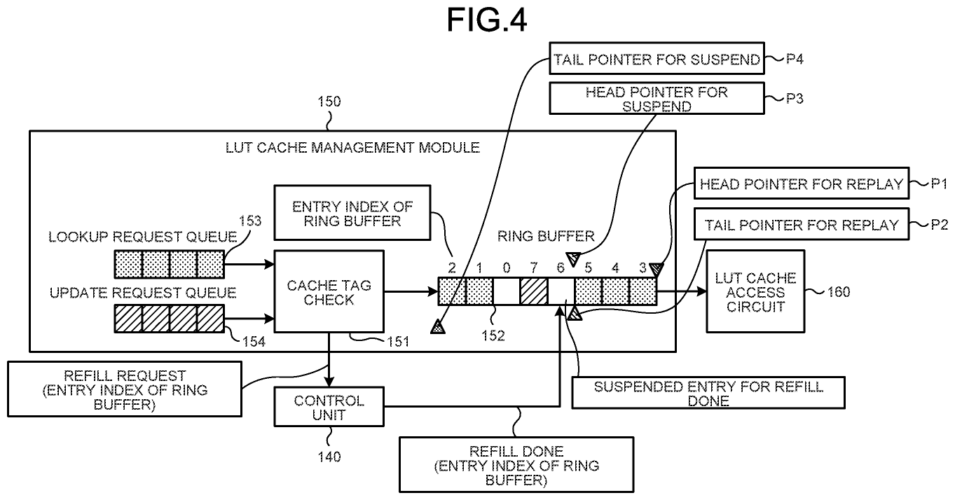

Here, FIG. 4 is a diagram schematically illustrating operation of the refill processing by the LUT cache management module 150. Although only one output suspend buffer 152 is illustrated in FIG. 4 for convenience, a plurality of output suspend buffers 152 are actually prepared.

The cache tag check unit 151 puts a request (a lookup request or an update request) that is put into the lookup request queue 153 or the update request queue 154 into the output suspend buffer 152 regardless of whether the result is the cache hit or the cache miss. When putting a request into the output suspend buffer 152, the cache tag check unit 151 sets a flag indicating the cache hit or the cache miss to the request.

The output suspend buffer 152 functions as a suspend queue in which the requests are input and output under the rule of arranging the lookup requests and the update requests in the queue in order of input and sequentially outputting the lookup requests and the update requests in first-in first-out order. The output suspend buffer 152 is managed by pointers P1 and P2 indicating a replay range, a pointer P3 indicating the head of the suspend queue of the output suspend buffer 152, and a pointer P4 indicating the tail of the suspend queue of the output suspend buffer 152.

At the time of the refill processing with the cache-miss LUT segment 131, the cache tag check unit 151 secures a buffer for refill with the target LUT segment 131 in the RAM 130. The secured buffer is used to store the cache-miss cache entry (LUT segment 131).

FIG. 4 illustrates that the LUT segments 131 with entry numbers (entry indices) ‘0’ and ‘6’ on the output suspend buffer 152 are the cache-miss LUT segments 131.

Also, at the time of the refill processing, the cache tag check unit 151 of the LUT cache management module 150 instructs the control unit 140 to perform the refill processing with the target LUT segment 131. The cache tag check unit 151 transmits to the control unit 140, as the refill request, an index number of the cache-miss LUT segment 131, an address of the secured buffer, and an entry number on the output suspend buffer 152 storing the cache-miss request. In the example illustrated in FIG. 4, the entry number ‘6’ on the output suspend buffer 152 storing the cache-miss request is included in the refill request.

The control unit 140 performs the refill processing with the target LUT segment 131 in accordance with the refill request transmitted from the cache tag check unit 151.

The control unit 140 reads the LUT segment 131 including the address translation information that associates the target logical address specified by the refill request with the physical address from the LUT 201 stored in the non-volatile memory 200. The control unit 140 stores the read LUT segment 131 into the buffer for refill secured in the RAM 130.

The control unit 140 then notifies the LUT cache management module 150 of the entry number (‘6’ in the example illustrated in FIG. 4) on the output suspend buffer 152 included in the transmitted refill request as a notification indicating completion of the refill processing.

Therefore, the control unit 140 executes, as the refill processing, processing of reading the LUT segment 131 targeted for the refill request from the LUT 201 and storing the read LUT segment 131 into the buffer for refill, and processing of notifying the LUT cache management module 150 that the reading of the LUT segment 131 is completed. As a result, the processing of the control unit 140 can be simplified.

The LUT cache management module 150 provides the requests on the output suspend buffer 152 to the LUT cache access circuit 160 in storage order. At this time, the LUT cache management module 150 does not let the requests on each output suspend buffer 152 overtake each other. The LUT cache management module 150 provides the cache-hit entry and the entry for which the cache miss occurs but the refill processing is completed to the LUT cache access circuit 160.

However, the LUT cache management module 150 does not provide the entry for which the cache miss occurs and the refill processing is not completed to the LUT cache access circuit 160. Therefore, in a case where there is an entry for which the cache miss occurs and the refill processing is not completed, the LUT cache management module 150 does not provide the entry and the subsequent entries on the output suspend buffer 152 to the LUT cache access circuit 160.

[Effect of First Embodiment]

As described above, according to the present embodiment, the LUT cache includes pipeline processing using two processing stages of processing (refill processing) of preparing a cache-miss cache entry from the LUT 201 and processing of providing a request to the LUT cache access circuit 160 after waiting for completion of the preparation of the cache entry. As a result, it is possible to achieve simplification of the hardware configuration and simplification of the processing performed by the control unit 140 while suppressing performance degradation at the time of a cache miss. More specifically, according to the present embodiment, the control unit 140 is only required to execute processing of preparing the LUT segment 131 (refill) and notifying the LUT cache management module 150 of completion of the preparation, and the simplification of the processing performed by the control unit 140 can thus be achieved.

Also, for example, in a case of applying an SSD to the memory system 1, even in a case where the RAM 130 (working memory) mounted in the SSD does not have a size enabling the entire LUT 201 to be stored, the cache management for the LUT 201 can efficiently be achieved.

Note that, according to the present embodiment, the LUT cache management module 150 prepares a free buffer for refill with the LUT segment 131, and uses the prepared buffer for the refill processing when a cache miss occurs. In a case of a fully associative cache method, a free buffer may be secured by invalidating a clean entry on the cache in advance in order to generate the free buffer. In this case, the LUT cache access circuit 160 may process the cache invalidation request without letting other preceding requests overtaken via the output suspend buffer 152, and return a cache invalidation completion notification (notification indicating that no request to the target buffer exists) to the LUT cache management module 150.

Also, in a case of an N-way cache method (in which a buffer for storing the LUT segment 131 is fixed by the index and the way of the cache), a copy request may be inserted immediately before an entry of a cache-miss request in the output suspend buffer 152, and when the refill is completed, the LUT segment 131 may be copied from a temporary buffer possessed by the LUT cache management module 150 to the buffer for the cache entry specified by the index and the way.

### Second Embodiment

Next, a second embodiment will be described. While the pipeline processing is performed in the case of a cache miss in the first embodiment, the second embodiment differs form the first embodiment in that replay from a suspend queue is performed in the case of a cache miss. Hereinafter, in the description of the second embodiment, description of the same portions as those in the first embodiment will be omitted or simplified, and different portions from those in the first embodiment will be described.

[Functional Configuration in Refill Processing of LUT Cache Management Module 150]

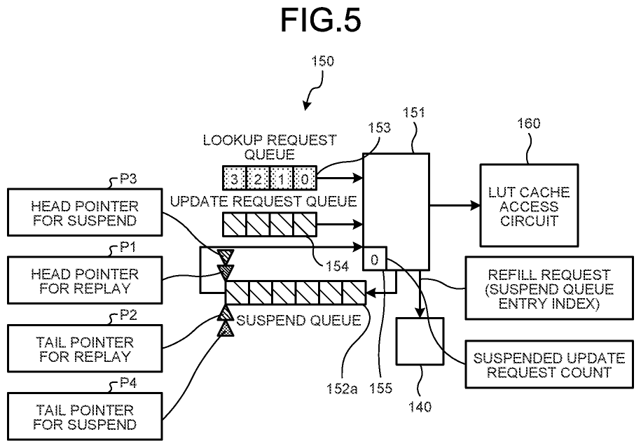

Here, FIG. 5 is a diagram schematically illustrating a functional configuration of the refill processing by the LUT cache management module 150 according to the second embodiment. In FIG. 5, the cache tag check unit 151 first performs a search in the RAM 130 in a case of receiving from the control unit 140 a logical address corresponding to a request (a lookup request or an update request) that is put into the lookup request queue 153 or the update request queue 154. In a case where the result of the search is a cache hit, the cache tag check unit 151 provides the cache-hit request to the LUT cache access circuit 160. Also, in a case where the result of the search is a cache miss, the cache tag check unit 151 puts the cache-miss request into an output suspend buffer 152a. The output suspend buffer 152a functions as a suspend queue for storing a request that cannot immediately be provided to the LUT cache access circuit 160 due to a cache miss. When putting a request into the output suspend buffer 152a, the cache tag check unit 151 stores into the LUT cache management module 150 whether or not the refill is performed for each of the requests in the output suspend buffer 152a.

At the time of the refill processing, the LUT cache management module 150 secures a buffer for refill with the LUT segment 131 in the RAM 130. The secured buffer is used to store the cache-miss cache entry (LUT segment 131).

Also, at the time of the refill processing, the cache tag check unit 151 instructs the control unit 140 to perform the refill processing with the target LUT segment 131. The cache tag check unit 151 transmits to the control unit 140, as the refill request, an index number of the cache-miss LUT segment 131, an address of the secured buffer, and an entry number on the output suspend buffer 152a storing the cache-miss request.

The cache tag check unit 151 replays (re-provides) the requests (the lookup requests or the update requests) on the output suspend buffer 152a in order of storage in the output suspend buffer 152a. At this time, the cache tag check unit 151 replays the entry for which the cache miss occurs but the refill processing is completed or the entry for which the cache hit occurs during the refill processing. Note that overtaking is not performed, and thus in a case where there is an entry for which the cache miss occurs but the refill processing is not completed, the entry and the subsequent entries are not to be replayed.

The cache tag check unit 151 counts the number of update requests that is put into the output suspend buffer 152a each time one update request is put into the output suspend buffer 152a from the update request queue 154. In a case where this counter is non-zero, the cache tag check unit 151 temporarily puts all subsequent new update requests into the output suspend buffer 152a. Accordingly, the LUT cache management module 150 guarantees the order in which the update requests are provided to the LUT cache access circuit 160. That is, the LUT cache management module 150 prevents a cache-miss request from being overtaken.

In the processing state illustrated in FIG. 5, the output suspend buffer 152a is empty. The output suspend buffer 152a includes pointers P1 and P2 indicating a replay range, a pointer P3 indicating the head of the suspend queue of the output suspend buffer 152a, and a pointer P4 indicating the tail of the suspend queue of the output suspend buffer 152a.

Also, as illustrated in FIG. 5, the cache tag check unit 151 includes a counter 155 that counts the number of update requests in the output suspend buffer 152a.

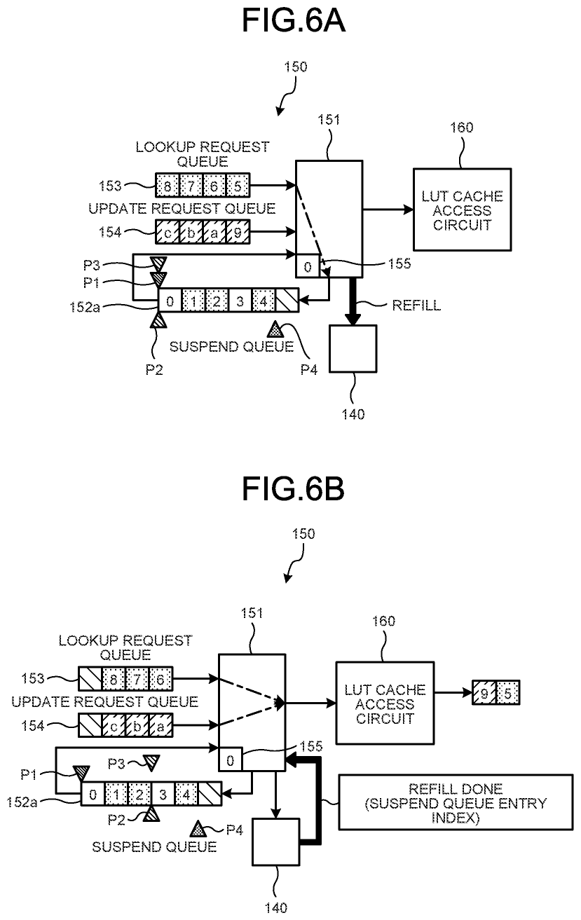

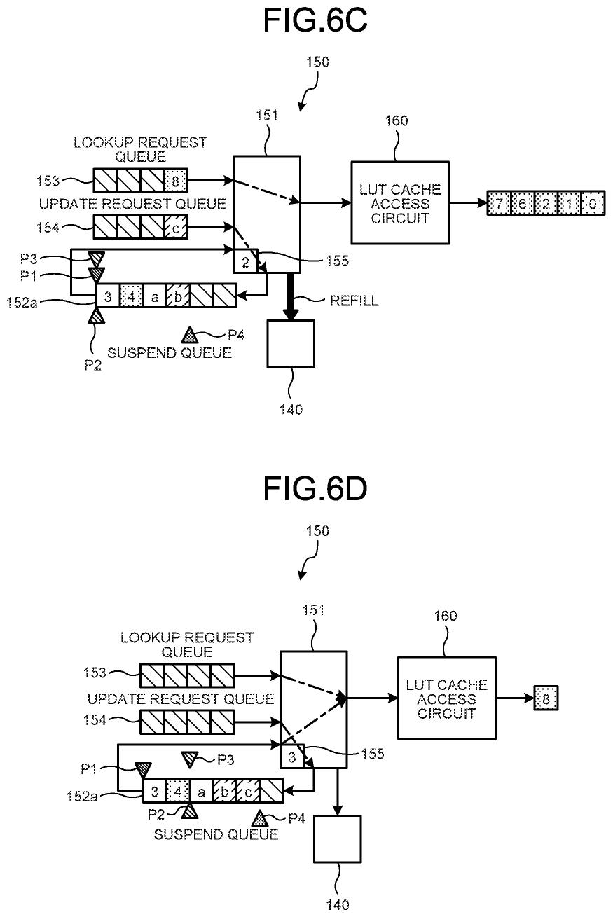

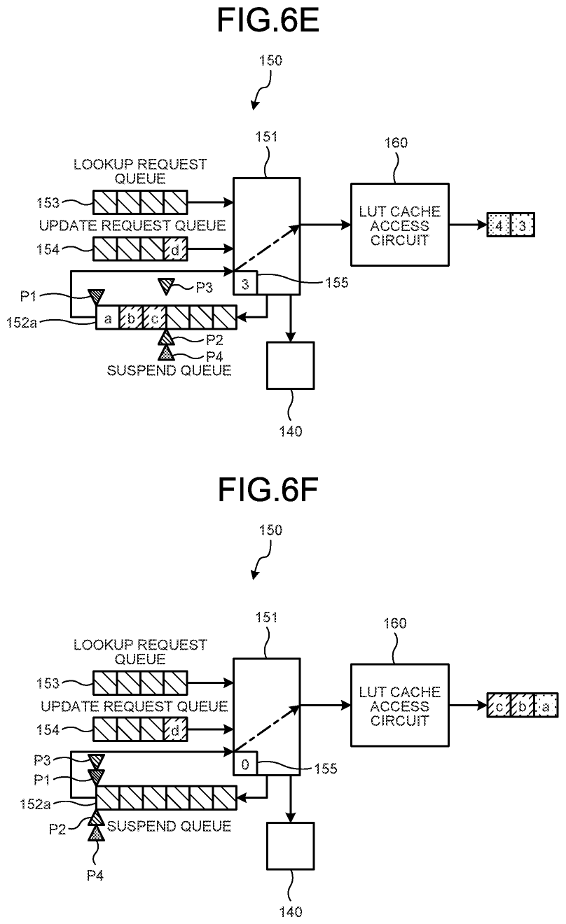

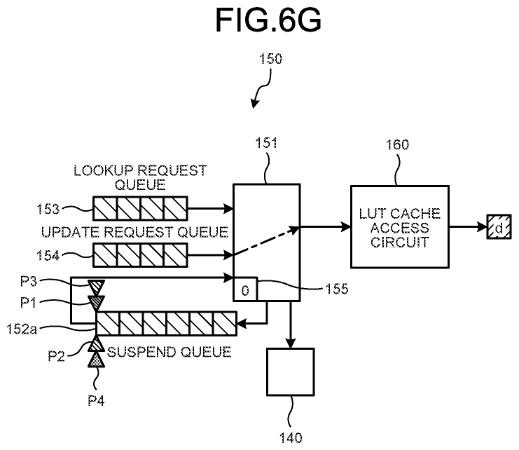

FIGS. 6A to 6G are diagrams schematically illustrating operation of the refill processing by the LUT cache management module 150.

As illustrated in FIG. 6A, the cache tag check unit 151 checks the cache tags, and puts a cache-miss request and a request that cannot be provided to the LUT cache access circuit 160 due to the refill processing into the output suspend buffer 152a serving as a suspend queue. The example illustrated in FIG. 6A indicates that the cache-miss request numbers are ‘0’ and ‘3’. The example indicates that the request numbers ‘1’ and ‘2’, and the request number ‘0’ are requests for the same LUT segment 131, and the request number ‘4’ and the request number ‘3’ are requests for the same LUT segment 131, and that each of the target LUT segment cannot be provided to the LUT cache access circuit 160 because the refill with the target LUT segment 131 is being performed.

Note that, as illustrated in FIG. 6A, since the request numbers ‘0’, ‘1’, ‘2’, ‘3’, and ‘4’ in the output suspend buffer 152a are lookup requests, the number of update requests in the output suspend buffer 152a indicated by the counter 155 is 0.

As illustrated in FIG. 6A, in a case where a cache miss occurs and the refill processing is required, the cache tag check unit 151 instructs the control unit 140 to perform the refill processing from the LUT 201. In this case, refill targets are ‘0’ and ‘3’.

On the other hand, as illustrated in FIG. 6B, the cache tag check unit 151 provides the cache-hit request to the LUT cache access circuit 160. In the example illustrated in FIG. 6B, the cache-hit request number ‘5’ is first provided to the LUT cache access circuit 160.

Subsequently, in a case where there is no suspended update request in the output suspend buffer 152a, the cache tag check unit 151 directly provides a cache-hit new update request to the LUT cache access circuit 160. In the example illustrated in FIG. 6B, the cache-hit new update request number ‘9’ is provided to the LUT cache access circuit 160. As for the lookup requests, the cache tag check unit 151 provides the cache-hit request to the LUT cache access circuit 160 regardless of the state of the output suspend buffer 152a.

Note that, as illustrated in FIG. 6B, since the request numbers ‘0’, ‘1’, ‘2’, ‘3’, and ‘4’ in the output suspend buffer 152a are lookup requests, the number of update requests in the output suspend buffer 152a counted by the counter 155 is 0.

As illustrated in FIG. 6B, when completing the refill processing, the control unit 140 notifies the LUT cache management module 150 of the completion of the refill processing.

As described above, the cache tag check unit 151 can directly provide to the LUT cache access circuit 160 the cache-hit lookup request (the request that does not need to maintain the processing order) even during the replay. However, in consideration of the latency of command processing, it is basically preferable to prioritize the replay from the output suspend buffer 152a.

As illustrated in FIGS. 6C to 6E, when the refill processing is completed, the cache tag check unit 151 replays the request in the output suspend buffer 152a.

Specifically, as illustrated in FIG. 6C, in a case where the refill processing for the request number ‘0’ is completed, the request number ‘0’, and then the request numbers ‘1’ and ‘2’, in which the cache miss does not occur but which have been suspended in the output suspend buffer 152a, are provided to the LUT cache access circuit 160. The cache-hit lookup request numbers ‘6’ and ‘7’ are also provided to the LUT cache access circuit 160. On the other hand, the cache-miss update request number ‘a’ is newly put into the output suspend buffer 152a since the cache miss occurs in the request number ‘a’, and the refill processing is required. Further, the update request number ‘b’, which follows the cache-miss update request number ‘a’, is put into the output suspend buffer 152a.

As illustrated in FIG. 6C, in a case where a cache miss occurs and the refill processing is required, the cache tag check unit 151 instructs the control unit 140 to perform the refill processing from the LUT 201. In this case, refill targets are ‘3’ and ‘a’.

As illustrated in FIG. 6C, since the request numbers ‘a’ and ‘b’ among the request numbers ‘3’, ‘4’, ‘a’, and ‘b’ in the output suspend buffer 152a are update requests, the number of update requests in the output suspend buffer 152a counted by the counter 155 is 2.

In this manner, in a case where there are update requests (the requests that need to maintain the processing order) in the output suspend buffer 152a, the cache tag check unit 151 does not directly provide a new update request to the LUT cache access circuit 160.

Subsequently, as illustrated in FIG. 6D, in a case where the refill processing for the request numbers ‘3’ and ‘a’ is not completed, the cache-hit lookup request number ‘8’ is provided to the LUT cache access circuit 160. On the other hand, since there are the update requests ‘a’ and ‘b’ in the output suspend buffer 152a, the update request number ‘c’ is put into the output suspend buffer 152a.

As illustrated in FIG. 6D, since the request numbers ‘a’, ‘b’, and ‘c’ among the request numbers ‘3’, ‘4’, ‘a’, ‘b’, and ‘c’ in the output suspend buffer 152a are update requests, the number of update requests in the output suspend buffer 152a counted by the counter 155 is 3.

That is, as illustrated in FIGS. 6C and 6D, in a case where there is an update request in the output suspend buffer 152a, the cache tag check unit 151 temporarily puts even a cache-hit new update request into the output suspend buffer 152a since the processing order needs to be maintained.

Subsequently, as illustrated in FIG. 6E, in a case where the refill processing for the request number ‘3’ is completed, the request number ‘3’, and then the request number ‘4’, for which the cache miss does not occur but which has been suspended in the output suspend buffer 152a, are provided to the LUT cache access circuit 160.

As illustrated in FIG. 6E, since the request numbers ‘a’, ‘b’, and ‘c’ in the output suspend buffer 152a are update requests, the number of update requests in the output suspend buffer 152a counted by the counter 155 is 3.

Subsequently, as illustrated in FIG. 6F, in a case where the refill processing for the request number ‘a’ is completed, the request number ‘a’, and then the request numbers ‘b’ and ‘c’, for which the cache miss does not occur but which have been suspended in the output suspend buffer 152a, are provided to the LUT cache access circuit 160.

As illustrated in FIG. 6F, since there is no update request in the output suspend buffer 152a, the number of update requests in the output suspend buffer 152a counted by the counter 155 is 0.

As illustrated in FIGS. 6F to 6G, in a case where the number of update requests in the output suspend buffer 152a is 0 in the counter 155, the cache tag check unit 151 can directly provide a cache-hit new update request to the LUT cache access circuit 160 again. Note that the replay processing is prioritized over the new request processing.

Specifically, as illustrated in FIGS. 6F to 6G, since the number of update request in the output suspend buffer 152a counted by the counter 155 is 0, the cache-hit new update request number ‘d’ is provided to the LUT cache access circuit 160.

[Effect of Second Embodiment]

As described above, according to the present embodiment, in a case where requests cannot be provided to the LUT cache access circuit 160 due to a cache miss or the like, the output suspend buffer 152a that temporarily stores the requests that cannot be provided is managed in the LUT cache management module 150. At the time of replay, the LUT cache management module 150 fetches the requests in the output suspend buffer 152a by itself and re-provides the requests to the LUT cache management module 150 to enable the processing load of the control unit 140 to be reduced.

Also, since the LUT cache management module 150 itself includes a mechanism for guaranteeing the order in which the requests are provided to the LUT cache access circuit 160, the control unit 140 does not need to manage the order guarantee. More specifically, since the request that does not need to guarantee the order can overtake the preceding request, an influence of the order guarantee on the performance is reduced.

Also, for example, in a case of applying an SSD to the memory system 1, even in a case where the RAM 130 (working memory) mounted in the SSD does not have a size enabling the entire LUT 201 to be stored, the cache management for the LUT 201 can efficiently be achieved.

Note that, according to the present embodiment, the LUT cache management module 150 prepares a free buffer for refill with the LUT segment 131, and uses the buffer when a cache miss occurs. In a case of a fully associative cache method, a free buffer is secured by invalidating a clean entry on the cache in advance in order to generate the free buffer. In this case, the LUT cache access circuit 160 may process the cache invalidation request without letting other preceding requests overtaken via the output suspend buffer 152a, and return a cache invalidation completion notification (notification indicating that no request to the target buffer exists) to the LUT cache management module 150 from the LUT cache access circuit 160.

Also, in a case of an N-way cache method (in which a buffer for storing LUT segment 131 is fixed by the index and the way of the cache), a copy request may be inserted immediately before an entry of a cache-miss request in the output suspend buffer 152a, and when the refill is completed, the LUT segment 131 may be copied from a temporary buffer possessed by the LUT cache management module 150 to the buffer for the cache entry specified by the index and the way.

Note that the memory controller 100 according to each of the embodiments is assumed to be a controller in a memory system including the non-volatile memory 200 such as an SSD, but is not limited thereto, and may be a controller device configured as a separate device from the non-volatile memory 200 serving as the first memory and the RAM 130 serving as the second memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile first memory configured to store data in a non-volatile manner, the first memory being configured to store first information that associates each of a plurality of logical addresses indicating a plurality of positions in a logical address space of the memory system with a corresponding one of physical addresses indicating physical positions in the first memory;
a second memory that includes a set-associative cache area storing second information that is a part of the first information regarding the plurality of logical addresses; and
a controller that includes a first circuit configured to control access to the first memory for the first information and a second circuit configured to control access to the second memory,
the controller being configured to execute third processing including first processing and second processing when a result of a search of a first logical address in the cache area storing the second information is a cache miss, the first processing being a process of transmitting a first request for preparation of a cache entry of the second information to the first circuit, the second processing being a process of providing a second request regarding the cache entry to the second circuit in response to reception of notification indicating completion of the preparation of the cache entry from the first circuit.

2. The memory system according to claim 1, wherein
the controller is configured to secure a buffer storing the cache entry of the second information in the second memory.

3. The memory system according to claim 2, wherein
the controller is configured to transmit, to the first circuit, as the first request, an identifier regarding the first logical address for which the cache miss occurs, an address of the buffer secured, and an identifier in a buffer for which the cache miss occurs.

4. The memory system according to claim 1, wherein
the controller is configured to provide, to the second circuit, a request regarding a cache entry regarding a second logical address for which a cache hit occurs or a request regarding a cache entry regarding a third logical address for which the cache miss occurs but the third processing is completed.

5. The memory system according to claim 1, wherein
the controller is configured to provide, to the second circuit, a request that does not need to guarantee a provision order to the second circuit to overtake a preceding request.

6. The memory system according to claim 5, wherein
the controller is configured to manage a buffer configured to store a request for which the cache miss occurs, and to store the request and information indicating that the request requires the third processing into the buffer.

7. The memory system according to claim 5, wherein
the controller is configured to provide, to the second circuit, an entry for which the cache miss occurs but the third processing is completed, or an entry for which the cache hit occurs during the third processing.

8. The memory system according to claim 5, wherein
the controller is configured to guarantee the provision order to the second circuit of requests that require update of the first information.

9. The memory system according to claim 1, wherein
the first processing and the second processing include pipeline processing.

10. A control method executed in a memory system that includes a first memory and a second memory, the method comprising:
storing, into the first memory, first information that associates each of a plurality of logical addresses indicating a plurality of positions in a logical address space of the memory system with a corresponding one of physical addresses indicating physical positions in the first memory;
storing, into a set-associative cache area included in the second memory, second information that is a part of the first information regarding the plurality of logical addresses; and
executing third processing including first processing and second processing when a result of a search of a first logical address in the cache area storing the second information is a cache miss, the first processing being a process of transmitting a first request for preparation of a cache entry of the second information, the second processing being a process of providing a second request regarding the cache entry in response to reception of notification indicating completion of the preparation of the cache entry.

11. The control method according to claim 10, further comprising:
securing a buffer storing the cache entry of the second information in the second memory.

12. The control method according to claim 11, further comprising:
transmitting, as the first request, an identifier regarding the first logical address for which the cache miss occurs, an address of the buffer secured, and an identifier in a buffer for which the cache miss occurs, to a first circuit configured to control access to the first memory for the first information.

13. The control method according to claim 10, further comprising:
providing, to a second circuit configured to control access to the second memory, a request regarding a cache entry regarding a second logical address for which a cache hit occurs or a request regarding a cache entry regarding a third logical address for which the cache miss occurs but the third processing is completed.

14. The control method according to claim 10, further comprising:
providing, to a second circuit configured to control access to the second memory, a request that does not need to guarantee a provision order to the second circuit to overtake a preceding request.

15. The control method according to claim 10, wherein
the first processing and the second processing include pipeline processing.

16. A memory controller configured to control a non-volatile first memory configured to store data in a non-volatile manner and a second memory,
the first memory being configured to store first information that associates each of a plurality of logical addresses indicating a plurality of positions in a logical address space of a memory system provided by the first memory with a corresponding one of physical addresses indicating physical positions in the first memory,
the second memory including a set-associative cache area storing second information that is a part of the first information regarding the plurality of logical addresses, and
the memory controller comprising:
a first circuit configured to control access to the first memory for the first information;
a second circuit configured to control access to the second memory; and
a processor configured to execute third processing including first processing and second processing when a result of a search of a first logical address in the cache area storing the second information is a cache miss, the first processing being a process of transmitting a first request for preparation of a cache entry of the second information to the first circuit, the second processing being a process of providing a second request regarding the cache entry to the second circuit in response to reception of notification indicating completion of the preparation of the cache entry from the first circuit.

17. The memory controller according to claim 16, wherein
the processor is configured to secure a buffer storing the cache entry of the second information in the second memory.

18. The memory controller according to claim 16, wherein
the processor is configured to provide, to the second circuit, a request regarding a cache entry regarding a second logical address for which a cache hit occurs or a request regarding a cache entry regarding a third logical address for which the cache miss occurs but the third processing is completed.

19. The memory controller according to claim 16, wherein
the processor is configured to provide, to the second circuit, a request that does not need to guarantee a provision order to the second circuit to overtake a preceding request.

20. The memory controller according to claim 16, wherein
the first processing and the second processing include pipeline processing.
